(19) United States
(12) Patent Application Publication
(10) Pub. No.: US 2004/0240038 A1
(43) Pub. Date: Dec. 2, 2004

(54) Raman amplification method and optical transmission system using the same

(75) Inventors: Soko Kado, Tokyo (JP); Yoshihiro Emori, Tokyo (JP); Shu Namiki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: The Furukawa Electric Co., Ltd., Tokyo (JP)

(21) Appl. No.: 10/781,900

(22) Filed: Feb. 20, 2004

Related U.S. Application Data
(63) Continuation of application No. PCT/JP02/08371, filed on Aug. 20, 2002.

(30) Foreign Application Priority Data
Aug. 21, 2001 (JP) 2001-250817
Oct. 3, 2001 (JP) 2001-307461

(51) Int. Cl. H01S 3/00

(52) U.S. Cl. 359/334

(57) ABSTRACT

In a Raman amplification method for pumping signal light with two or more pumping lights that have different wavelengths, the wavelengths and powers of the two or more pumping lights are combined, a part or all of the combined pumping lights are used for bidirectional pumping, and distribution of power of pumping light to the wavelengths is changed while the total power in the bidirectional pumping is not changed or is hardly changed. A part of the combined pumping lights are used for the forward pumping whereas all the pumping lights used in the combinations are used for the backward pumping. Among the combined pumping lights, the pumping lights on the short wavelength side are used for the forward pumping whereas all the pumping lights used in the combinations are used for the backward pumping. In any combination, the power of the backward pumping light is larger than that of the forward pumping light. The LD used is iGM (trademark of an LD applied for trademark registration by the present applicant of this application).

### TECHNICAL FIELD

The present invention relates to a Raman amplification method for use in optical communications and an optical transmission system using such a method.

### BACKGROUND ART

Recent years have seen a rapid increase in data size in optical communications, and a broader transmission capacity is being demanded. To meet the demand, WDM transmission has come to be used widely as an optical transmission system capable of large-capacity transmission. Raman amplifiers are attracting attention as optical amplifiers that can expand the transmission band, which is indispensable in increasing the transmission capacity of WDM transmission.

One of characteristics of Raman amplifiers resides in distributed amplifiers which an optical transmission fiber serves as an amplification medium. This characteristic gives Raman amplifiers a noise characteristic superior to that of conventional discrete optical amplifiers, which use as an amplification medium a short doped optical fiber of several tens m in length, typically an EDFA (Erbium-Doped Fiber Amplifier).

The noise characteristic of an optical transmission system and of a Raman amplifier used in the system is expressed by NF (Noise Figure). NF is a parameter showing the ratio between an SNR (signal-to-noise ratio) before amplification and an SNR after amplification in an optical amplifier. A system having a smaller NF value is a system with a better noise characteristic.

As shown in FIG. 6, NF becomes larger as a transmission fiber used as an amplification medium becomes longer. This is because a longer fiber length means a larger transmission loss, which results in attenuation of signal light and a relative increase in noise.

Under equal pumping conditions, NF's wavelength characteristics in forward pumping and in backward pumping are as shown in FIG. 5. In backward pumping, signal light is propagated within an optical fiber prior to the amplification whereas in forward pumping signal light is amplified and then propagated in an optical fiber. Accordingly, NF is smaller in forward pumping than in backward pumping.

The major factor of NF's wavelength dependency is a wavelength characteristic of transmission loss of a fiber. In NZ-DSFs (Non-Zero Dispersion-Shifted Fibers), which are usually used as transmission fibers and simultaneously serve as amplification medium in distributed Raman amplifiers, and DCFs (Dispersion Compensation Fibers), which are used as amplification media in discrete Raman amplifiers, the transmission loss is large on the short wavelength side and therefore NF tends to increase on the short wavelength side.

Accordingly, a longer transmission fiber results in not only an increase in NF due to increase of loss but also an increase in wavelength dependency due to accumulated deviation of loss at each wavelength. As shown in FIG. 6, the NF deviation between different signal light wavelengths becomes larger as a transmission fiber becomes longer. In particular, when the fiber length is several tens km, which is the interval between repeaters of a transmission system, or longer, the NF deviation reaches an unignorable level. In addition, when the interval between repeaters is short, the accumulated fiber length directly increases NF's wavelength dependency unless plural Raman amplifiers are used as repeaters and NF's wavelength characteristic is canceled among the repeaters.

NF can be reduced by forward pumping as described above. However, an attempt to achieve high-gain amplification while reducing NF solely by forward pumping could degrade noise characteristics by other factors such as an increase in RIN (Relative Intensity Noise). In addition, forward pumping cannot solve the wavelength dependency, and neither can backward pumping. Then NF remains large on the short wavelength side where the transmission loss is large.

A large NF and large RIN invite distortion of signal light and therefore are undesirable from the viewpoint of signal light transmission quality. Also, too large a deviation of NF between signal light channels makes the transmission quality uneven, which is problematic for the system.

### DISCLOSURE OF THE INVENTION

An object of the present invention is to solve the above problems regarding NF and to provide a Raman amplification method capable of obtaining a flat transmission characteristic in a signal light band more efficiently.

A Raman amplification method according to one aspect of the present invention is a Raman amplification method for pumping signal light with two or more pumping lights that have different wavelengths in a Raman amplifier that uses a fiber as an amplification medium, the method including combining the wavelengths and powers of the two or more pumping lights to obtain through backward pumping a flat Raman gain within a signal light band, and using a part or all of the combined pumping lights for bidirectional pumping, wherein, in the bidirectional pumping, distribution of the power of pumping light to wavelengths is changed from that of backward pumping.

In a Raman amplification method according to another aspect of the present invention, in the bidirectional pumping, the distribution of the power of pumping light to wavelengths is changed from that of backward pumping while a total power in bidirectional pumping is not changed.

In a Raman amplification method according to another aspect of the present invention, in the bidirectional pumping, a part of the combined pumping lights are used for forward pumping whereas all pumping lights used in the combinations are used for backward pumping and distribution of the power of pumping light to wavelengths is changed from that of backward pumping.

In a Raman amplification method according to another aspect of the present invention, in the bidirectional pumping, a part of the combined pumping lights are used for forward pumping whereas all pumping lights used in the combinations are used for backward pumping and distribution of the power of pumping light to wavelengths is changed from that of backward pumping while a total power in bidirectional pumping is not changed.

In a Raman amplification method according to another aspect of the present invention, in the bidirectional pumping, pumping lights on a short wavelength side out of the combined pumping lights are used for forward pumping whereas all pumping lights used in the combinations are used for backward pumping and distribution of the power of pumping light to wavelengths is changed from that of backward pumping.

In a Raman amplification method according to another aspect of the present invention, in the bidirectional pumping, pumping lights on a short wavelength side out of the combined pumping lights are used for forward pumping whereas all pumping lights used in the combinations are used for backward pumping and distribution of the power of pumping light to wavelengths is changed from that of backward pumping while a total power in bidirectional pumping is not changed.

In a Raman amplification method according to another aspect of the present invention, in the bidirectional pumping, distribution of the power of pumping light to wavelengths is changed from that of backward pumping and the power of backward pumping light is set larger than the power of forward pumping light in any combination.

In a Raman amplification method according to another aspect of the present invention, in the bidirectional pumping, distribution of the power of pumping light to wavelengths is changed from that of backward pumping while a total power in bidirectional pumping is not changed and the power of backward pumping light is set larger than the power of forward pumping light in any combination.

In a Raman amplification method according to another aspect of the present invention, in the bidirectional pumping, a part of the combined pumping lights are used for forward pumping whereas all pumping lights used in the combinations are used for backward pumping, distribution of the power of pumping light to wavelengths is changed from that of backward pumping, and the power of backward pumping light is set larger than the power of forward pumping light in any combination.

In a Raman amplification method according to another aspect of the present invention, in the bidirectional pumping, a part of the combined pumping lights are used for forward pumping whereas all pumping lights used in the combinations are used for backward pumping, distribution of the power of pumping light to wavelengths is changed from that of backward pumping while a total power in bidirectional pumping is not changed, and the power of backward pumping light is set larger than the power of forward pumping light in any combination.

In a Raman amplification method according to another aspect of the present invention, in the bidirectional pumping, pumping lights on a short wavelength side out of the combined pumping lights are used for forward pumping whereas all pumping lights used in the combinations are used for backward pumping, distribution of the power of pumping light to wavelengths is changed from that of backward pumping, and the power of backward pumping light is set larger than the power of forward pumping light in any combination.

In a Raman amplification method according to another aspect of the present invention, in the bidirectional pumping, pumping lights on a short wavelength side out of the combined pumping lights are used for forward pumping whereas all pumping lights used in the combinations are used for backward pumping, distribution of the power of pumping light to wavelengths is changed from that of backward pumping while a total power in bidirectional pumping is not changed, and the power of backward pumping light is set larger than the power of forward pumping light in any combination.

In a Raman amplification method according to another aspect of the present invention, in the bidirectional pumping, distribution of the power of pumping light to wavelengths is changed from that of backward pumping and a multi-mode pumping laser with an LD chip having a wavelength-stabilizing grating structure is employed as a forward pumping light source.

In a Raman amplification method according to another aspect of the present invention, in the bidirectional pumping, distribution of the power of pumping light to wavelengths is changed from that of backward pumping while a total power in bidirectional pumping is not changed, and a multi-mode pumping laser with an LD chip having a wavelength-stabilizing grating structure is employed as a forward pumping light source.

In a Raman amplification method according to another aspect of the present invention, in the bidirectional pumping, a part of the combined pumping lights are used for forward pumping whereas all pumping lights used in the combinations are used for backward pumping, distribution of the power of pumping light to wavelengths is changed from that of backward pumping, and a multi-mode pumping laser with an LD chip having a wavelength-stabilizing grating structure is employed as a forward pumping light source.

In a Raman amplification method according to another aspect of the present invention, in the bidirectional pumping, a part of the combined pumping lights are used for forward pumping whereas all pumping lights used in the combinations are used for backward pumping, distribution of the power of pumping light to wavelengths is changed from that of backward pumping while a total power in bidirectional pumping is not changed, and a multi-mode pumping laser with an LD chip having a wavelength-stabilizing grating structure is employed as a forward pumping light source.

In a Raman amplification method according to another aspect of the present invention, in the bidirectional pumping, pumping lights on a short wavelength side out of the combined pumping lights are used for forward pumping whereas all pumping lights used in the combinations are used for backward pumping, distribution of the power of pumping light to wavelengths is changed from that of backward pumping, and a multi-mode pumping laser with an LD chip having a wavelength-stabilizing grating structure is employed as a forward pumping light source.

In a Raman amplification method according to another aspect of the present invention, in the bidirectional pumping, pumping lights on a short wavelength side out of the combined pumping lights are used for forward pumping whereas all pumping lights used in the combinations are used for backward pumping, distribution of the power of pumping light to wavelengths is changed from that of backward pumping while a total power in bidirectional pumping is not changed, and a multi-mode pumping laser with an LD chip having a wavelength-stabilizing grating structure is employed as a forward pumping light source.

In a Raman amplification method according to another aspect of the present invention, in the bidirectional pumping, distribution of the power of pumping light to wavelengths is changed from that of backward pumping while the power of backward pumping light is set larger than the power of forward pumping light in any combination, and a multi-mode pumping laser with an LD chip having a wavelength-stabilizing grating structure is employed as a forward pumping light source.

In a Raman amplification method according to another aspect of the present invention, in the bidirectional pumping, distribution of the power of pumping light to wavelengths is changed from that of backward pumping while a total power in bidirectional pumping is not changed, the power of backward pumping light is set larger than the power of forward pumping light in any combination, and a multi-mode pumping laser with an LD chip having a wavelength-stabilizing grating structure is employed as a forward pumping light source.

In a Raman amplification method according to another aspect of the present invention, in the bidirectional pumping, a part of the combined pumping lights are used for forward pumping whereas all pumping lights used in the combinations are used for backward pumping, distribution of the power of pumping light to wavelengths is changed from that of backward pumping, the power of backward pumping light is set larger than the power of forward pumping light in any combination, and a multi-mode pumping laser with an LD chip having a wavelength-stabilizing grating structure is employed as a forward pumping light source.

In a Raman amplification method according to another aspect of the present invention, in the bidirectional pumping, a part of the combined pumping lights are used for forward pumping whereas all pumping lights used in the combinations are used for backward pumping, distribution of the power of pumping light to wavelengths is changed from that of backward pumping while a total power in bidirectional pumping is not changed, the power of backward pumping light is set larger than the power of forward pumping light in any combination, and a multi-mode pumping laser with an LD chip having a wavelength-stabilizing grating structure is employed as a forward pumping light source.

In a Raman amplification method according to another aspect of the present invention, in the bidirectional pumping, pumping lights on a short wavelength side out of the combined pumping lights are used for forward pumping whereas all pumping lights used in the combinations are used for backward pumping, distribution of the power of pumping light to wavelengths is changed from that of backward pumping, the power of backward pumping light is set larger than the power of forward pumping light in any combination, and a multi-mode pumping laser with an LD chip having a wavelength-stabilizing grating structure is employed as a forward pumping light source.

In a Raman amplification method according to another aspect of the present invention, in the bidirectional pumping, pumping lights on a short wavelength side out of the combined pumping lights are used for forward pumping whereas all pumping lights used in the combinations are used for backward pumping, distribution of the power of pumping light to wavelengths is changed from that of backward pumping while a total power in bidirectional pumping is not changed, the power of backward pumping light is set larger than the power of forward pumping light in any combination, and a multi-mode pumping laser with an LD chip having a wavelength-stabilizing grating structure is employed as a forward pumping light source.

A Raman amplification method of the present invention is a Raman amplification method according to any one of the above-mentioned aspects of the present invention which uses two or more Raman amplifiers that constitute an optical transmission system, wherein one Raman amplification array is composed of one or more Raman amplifiers in which NF generally decreases as the wavelength is increased within the signal light band, and the other Raman amplifier array is composed of one or more Raman amplifiers in which distribution of the power of each pumping light in each Raman amplifier is set such that NF generally increases as the wavelength is increased within a signal light band.

The present invention relates to an optical transmission system, the optical transmission system including two or more Raman amplifiers, wherein one Raman amplification array is composed of one or more Raman amplifiers in which NF generally decreases as the wavelength is increased within the signal light band, and the other Raman amplifier array is composed of one or more Raman amplifiers in which distribution of the power of each pumping light in each Raman amplifier is set such that NF generally increases as the wavelength is increased within a signal light band.

### BRIEF DESCRIPTION OF THE DRAWINGS

FIG. 1 is an explanatory diagram for a Raman amplification method of the present invention.

FIG. 2 is an explanatory diagram for Embodiment 1 of a Raman amplification method of the present invention.

FIG. 3 is an explanatory diagram for Embodiment 2 of a Raman amplification method of the present invention.

FIG. 4 is an explanatory diagram for Embodiment 3 of a Raman amplification method of the present invention.

FIG. 5 is an explanatory diagram showing the relation between the wavelength and NF in forward pumping and backward pumping in a Raman amplifier.

FIG. 6 is an explanatory diagram showing the relation between the fiber length and NF in Raman amplification.

FIG. 7 is an explanatory diagram for backward pumping according to a Raman amplification method of the present invention.

FIG. 8 is an explanatory diagram for bidirectional pumping according to a Raman amplification method of the present invention.

FIG. 9 is an explanatory diagram for Embodiment 4 of a Raman amplification method of the present invention.

FIG. 10 is an explanatory diagram for Embodiment 5 of a Raman amplification method of the present invention.

FIG. 11 is an explanatory diagram showing the relation between the signal light wavelength and Raman gain in a Raman amplifier.

FIG. 12 is an explanatory diagram showing the relation between the signal light wavelength and Raman gain in a Raman amplifier.

FIG. 13 is an explanatory diagram showing an example of an optical transmission system that uses Raman amplifiers A and B as optical repeaters.

FIG. 14 is an explanatory diagram of NF of the Raman amplifier A used in FIG. 13.

FIG. 15 is an explanatory diagram of NF of the Raman amplifier B used in FIG. 13.

FIG. 16 is an explanatory diagram of NF of the transmission system of FIG. 13.

### BEST MODE FOR CARRYING OUT THE INVENTION

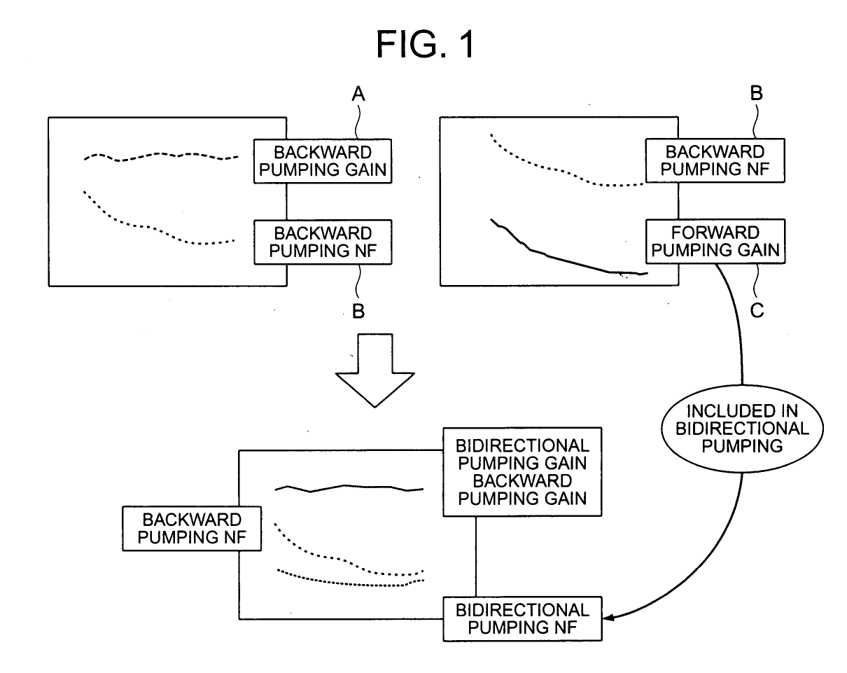

An example of a Raman amplification method of the present invention will be described with reference to FIG. 1. In this embodiment, a combination of a pumping wavelength and a pumping power is calculated to obtain through backward pumping a flat gain (a backward pumping gain: A in FIG. 1) in an arbitrary signal light band. Calculated next is a power of forward pumping light with which a gain (a forward pumping gain: C in FIG. 1) that has approximately the same tilt as the NF (a backward pumping NF: B in FIG. 1) at this point is obtained. Using pumping light that includes this forward pumping light, bidirectional pumping is carried out. In this bidirectional pumping, distribution of the power of pumping light to wavelengths is changed but the total power of pumping light is not changed. In other words, the total power in the bidirectional pumping is set equal to the total power in the backward pumping described above.

(Embodiment 1)

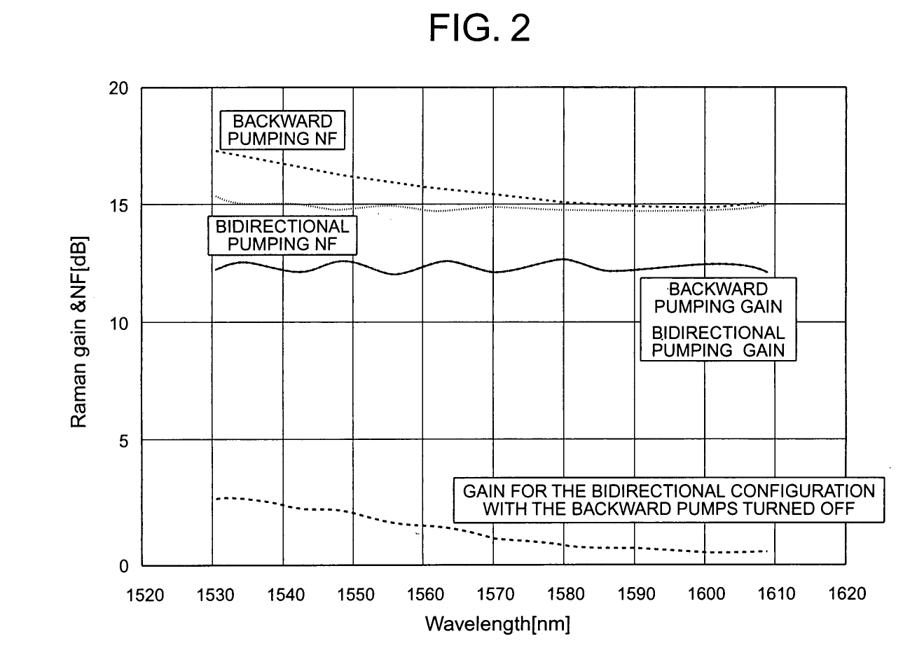

Shown in Table 1 are combinations of a pumping wavelength and a pumping power that can provide a flat gain through backward pumping (backward pumping gain). Using the three waves on the short wavelength side for forward pumping and all pumping lights used in the combinations (all wavelengths: 5 waves) for backward pumping, pumping is carried out while changing power distribution to the wavelengths but not the total power of these pumping lights (setting the total power equal to that in backward pumping). For each wavelength, the power of backward pumping light is set larger than that of forward pumping light. As shown in FIG. 2, the gain and NF are both flat in Raman amplification according to this experiment.

TABLE 1

| | | Bidirectional pumping | | | |
|---|---|---|---|---|---|
| | | Forward | | Backward | |
| Pumping | Backward | pumping | | pumping | |
| wavelength | pumping power | power | | power | |
| nm | mW | | mW | | mW |
| 1426.2 | 166.0 | | 33.2 | | 105.6 |
| 1438.5 | 158.0 | | 34.8 | | 106.2 |
| 1451.8 | 89.0 | | 21.4 | | 64.2 |
| 1466.0 | 81.0 | | 0 | | 94.6 |
| 1495.2 | 142.0 | | 0 | | 176.0 |
| Total power | 636.0 | Subtotal | 89.4 | Subtotal | 546.6 |

| | |
|---|---|
| mW | Total power 636.0 |

(Embodiment 2)

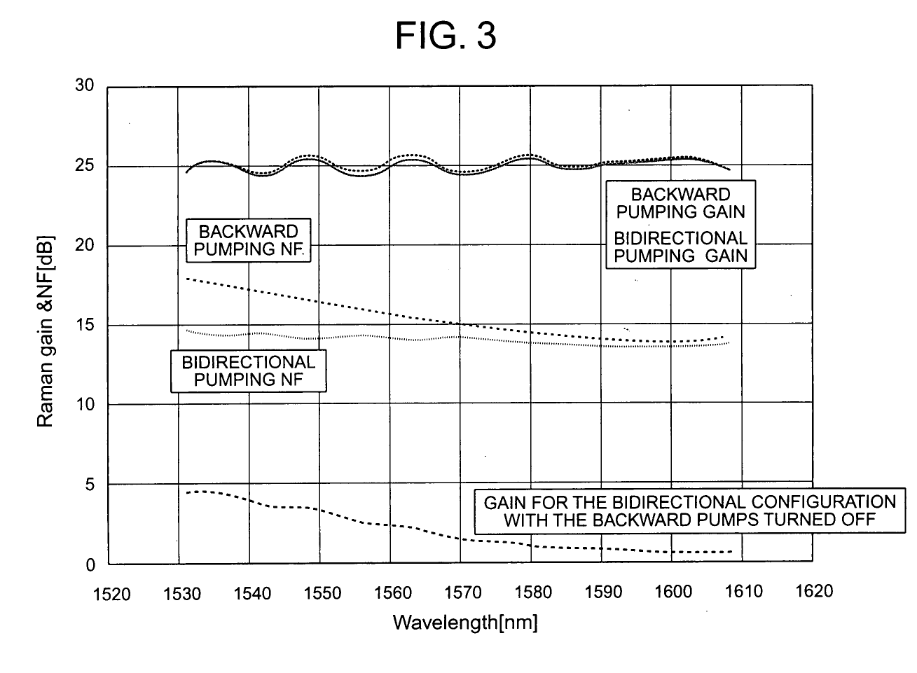

Shown in Table 2 are combinations of a pumping wavelength and a pumping power that can provide a flat gain through backward pumping (backward pumping gain). Using the three waves on the short wavelength side for forward pumping and all pumping lights used in the combinations (all wavelengths: 5 waves) for backward pumping, pumping is carried out while changing power distribution to the wavelengths but not the total power of these pumping lights (setting the total power equal to that in backward pumping). For each wavelength, the power of backward pumping light is set larger than that of forward pumping light. As shown in FIG. 3, the gain and NF are both flat in Raman amplification according to this experiment.

TABLE 2

| | | Bidirectional pumping | | | |
|---|---|---|---|---|---|
| Pumping | Backward | Forward pumping | | Backward pumping | |
| wavelength | pumping power | power | | power | |
| nm | mW | | mW | | mW |
| 1426.2 | 500.0 | | 65.0 | | 370.0 |
| 1438.5 | 430.0 | | 63.0 | | 340.0 |
| 1451.8 | 220.0 | | 30.0 | | 195.0 |
| 1466.0 | 140.0 | | 0 | | 170.0 |
| 1495.2 | 124.0 | | 0 | | 181.0 |
| Total power | 1414.0 | Subtotal | 158.0 | Subtotal | 1256.0 |

| | |
|---|---|
| mW | Total power 1414.0 |

(Embodiment 3)

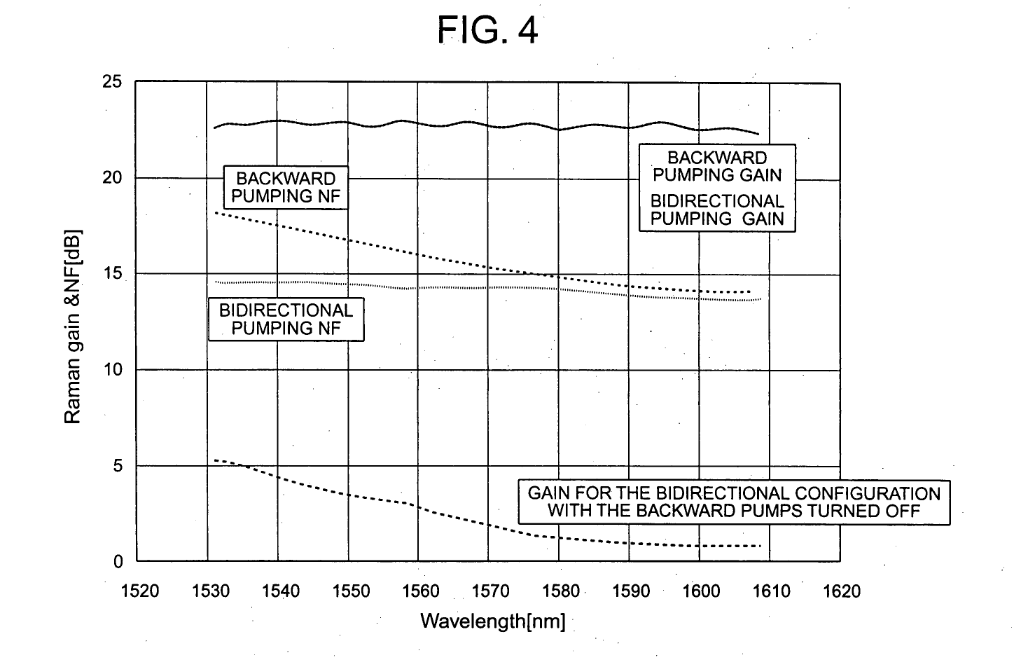

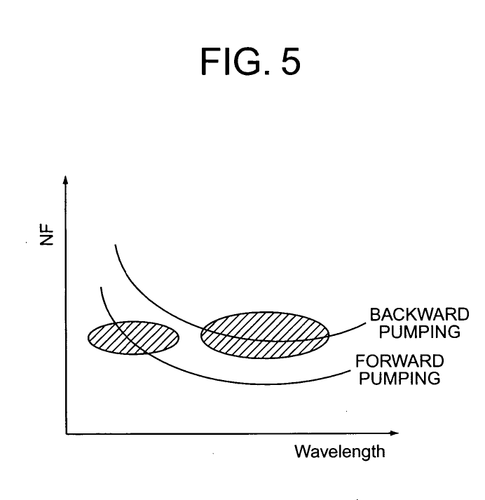

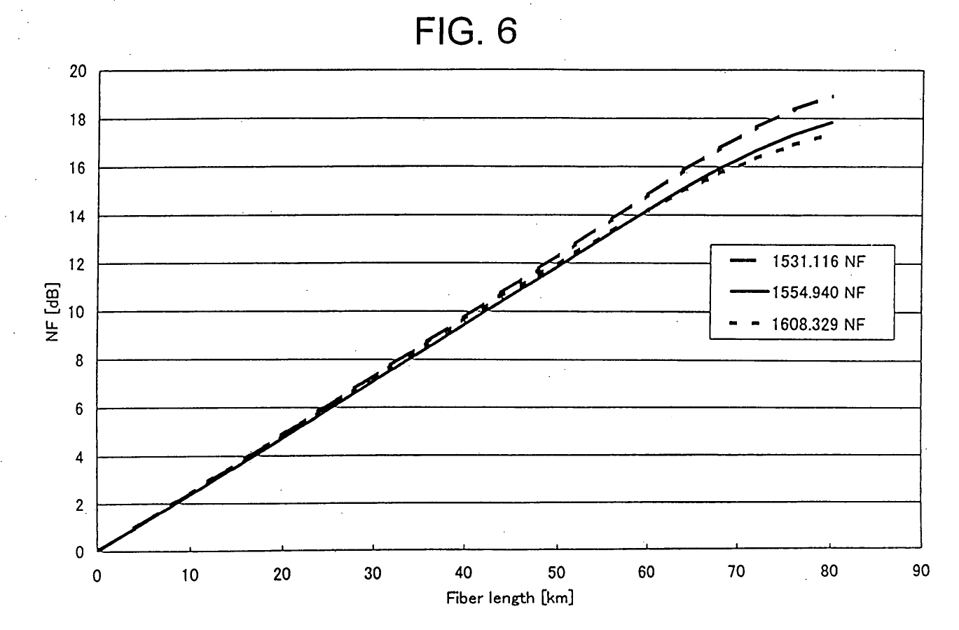

Shown in Table 3 are combinations of a pumping wavelength and a pumping power that can provide a flat gain through backward pumping (backward pumping gain). Using the five waves on the short wavelength side for forward pumping and all pumping lights used in the combinations (all wavelengths: 9 waves) for backward pumping, pumping is carried out while changing power distribution to the wavelengths but not the total power of these pumping lights (setting the total power equal to the one in backward pumping). For each wavelength, the power of backward pumping light is set larger than that of forward pumping light. As shown in FIG. 4, the gain and NF are both flat in Raman amplification according to this experiment.

TABLE 3

| | | Bidirectional pumping | | | |
|---|---|---|---|---|---|
| Pumping | Backward | Forward pumping | | Backward pumping | |
| wavelength | pumping power | power | | power | |
| nm | mW | | mW | | mW |
| 1424.2 | 322.0 | | 77.0 | | 117.0 |
| 1431.7 | 250.0 | | 35.0 | | 197.0 |
| 1439.2 | 235.0 | | 30.0 | | 198.0 |
| 1446.9 | 145.0 | | 20.0 | | 141.0 |
| 1454.6 | 110.0 | | 22.0 | | 95.0 |
| 1462.4 | 78.0 | | 0 | | 100.0 |
| 1470.3 | 55.0 | | 0 | | 74.0 |
| 1478.3 | 50.0 | | 0 | | 71.0 |
| 1500.5 | 90.0 | | 0 | | 158.0 |
| Total power | 1335.0 | Subtotal | 184.0 | Subtotal | 1151.0 |

| | |
|---|---|
| mW | Total power 1335.0 |

(Embodiment 4)

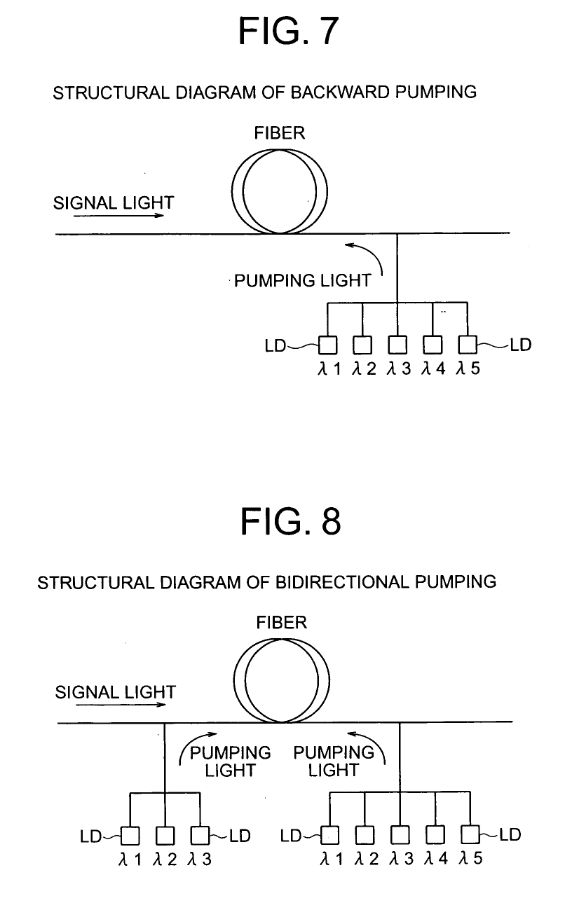

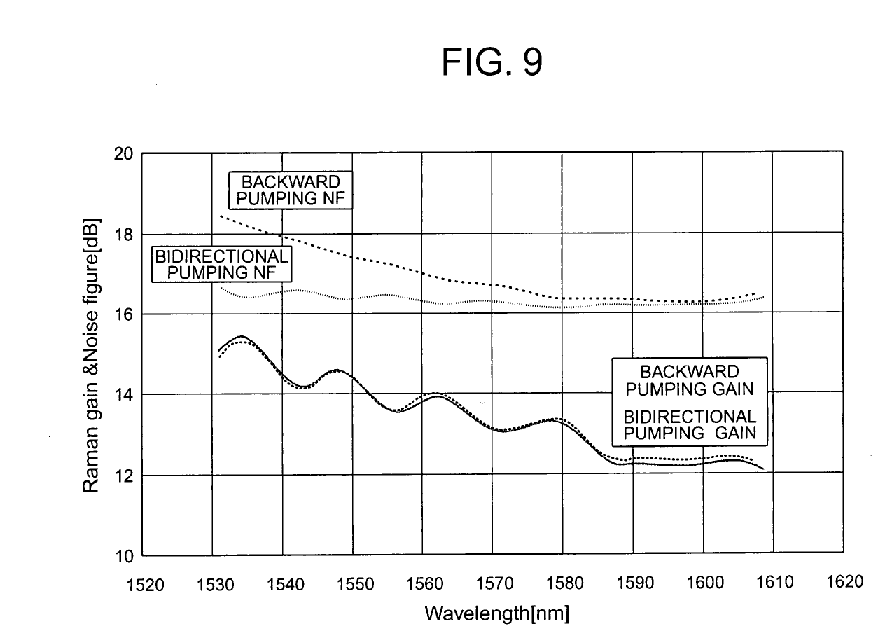

A gain that has a tilt shown in FIG. 9 is obtained by carrying out backward pumping as illustrated in FIG. 7 using combinations of a pumping wavelength and a pumping light source power that are shown in Table 4. As shown in FIG. 8, the three waves on the short wavelength side in Table 4 are used as forward pumping lights and all pumping lights used in the combinations (all wavelengths: 5 waves) are used for backward pumping to carry out bidirectional pumping by using the power distribution of Table 4 without changing the total power of the pumping lights. For each wavelength, the power of backward pumping light has been set larger than that of forward pumping light. In this way, Raman amplification in which NF is flat can be achieved without changing the gain as shown in FIG. 9.

TABLE 4

| | | Bidirectional pumping | | | |
|---|---|---|---|---|---|
| Pumping | Backward | Forward pumping | | Backward pumping | |
| wavelength | pumping power | power | | power | |
| nm | mW | | mW | | mW |
| 1426.2 | 277.0 | | 45.0 | | 197.0 |
| 1438.5 | 206.0 | | 30.0 | | 176.0 |
| 1451.8 | 100.0 | | 10.0 | | 90.0 |
| 1466.0 | 95.0 | | 0 | | 107.0 |
| 1495.2 | 112.0 | | 0 | | 135.0 |
| Total power | 790.0 | Subtotal | 85.0 | Subtotal | 705.0 |

| | |
|---|---|
| mW | Total power 790.0 |

(Embodiment 5)

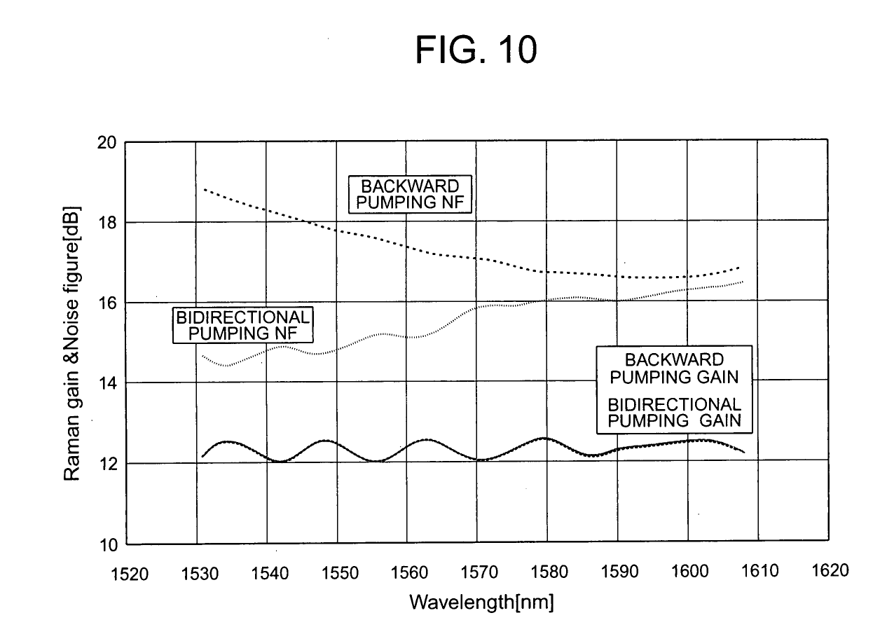

Shown in Table 5 are combinations of a pumping wavelength and a pumping power that can provide a flat gain through backward pumping. As shown in FIG. 8, the three waves on the short wavelength side in Table 4 are used as forward pumping lights and all pumping lights used in the combinations (all wavelengths: 5 waves) are used for backward pumping to carry out bidirectional pumping by using the power distribution of Table 5 without changing the total power of the pumping lights. For each wavelength, the power of backward pumping light is set larger than that of forward pumping light. In this way, Raman amplification amplifications whose tilts in NF are opposite each other can be achieved without changing the gain as shown in FIG. 10.

TABLE 5

| | | Bidirectional pumping | | | |
|---|---|---|---|---|---|
| Pumping | Backward | Forward pumping | | Backward pumping | |
| wavelength | pumping power | power | | power | |
| nm | mW | | mW | | mW |
| 1426.2 | 185.0 | | 88.0 | | 21.0 |
| 1438.5 | 165.0 | | 64.0 | | 74.0 |
| 1451.8 | 101.0 | | 56.0 | | 28.0 |
| 1466.0 | 85.0 | | 0 | | 111.0 |
| 1495.2 | 155.0 | | 0 | | 249.0 |
| Total power | 691.0 | Subtotal | 208.0 | Subtotal | 483.0 |

| | |
|---|---|
| mW | Total power 691.0 |

In each of the experiments of Embodiment 1 through Embodiment 5, a single mode fiber (SMF) having a length of 80 km is used for a fiber that serves as an amplification medium. FIGS. 7 and 8 show structural examples of backward pumping and bidirectional pumping in the present invention. The LDs in FIGS. 7 and 8 can be existing LDs, or LDs developed by the applicant of the present invention (iGM: a trademark (pending) of the applicant of the invention), or other LDs. The iGM laser is a multi-mode pumping laser in which an LD chip has a grating structure for stabilizing the wavelength.

(Embodiment 6)

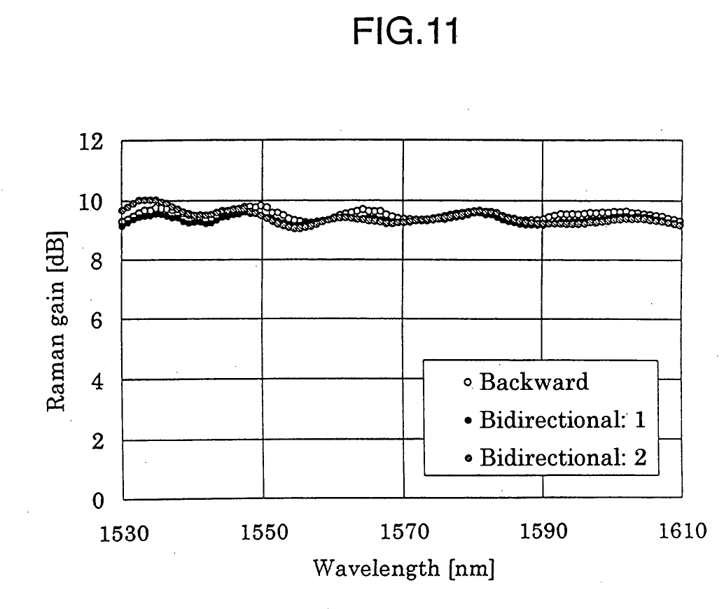

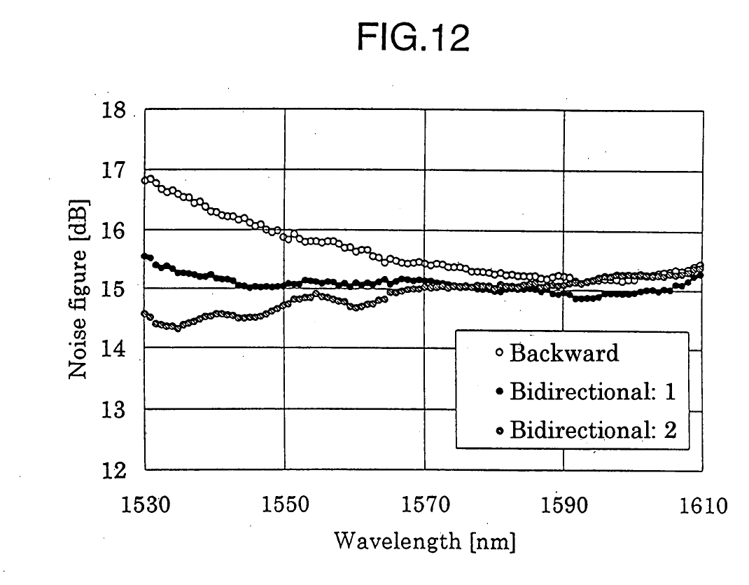

Using the structure of FIG. 8, an experiment is carried out through backward pumping and bidirectional pumping in two patterns. Pumping wavelengths used are as shown in Table 6. Employed for a fiber that serves as an amplification medium is a single mode fiber (SMF) with a length of 76 km. The obtained results are shown in FIGS. 11 and 12. The gain is the same in backward pumping and each of the two patterns of bidirectional pumping in Table 6 (FIG. 11) whereas NF in backward pumping becomes higher on the short wavelength side as shown in FIG. 12. In bidirectional pumping, on the other hand, NF is flat or tilted in a manner opposite to the tilt of NF of backward pumping depending on the distribution of pumping power. In this experiment, the total power is slightly reduced in Bidirectional Pumping 2 as compared with that in backward pumping or Bidirectional Pumping 1 as shown in Table 6, but the reduction is not large and is within the range of error in an experiment.

TABLE 6
Pumping Power in Experiment

| | | | Bidirectional | | Bidirectional | |
|---|---|---|---|---|---|---|
| | Pump- | | pumping: 1 | | pumping: 2 | |
| | ing | Backward | Forward | Backward | Forward | Backward |
| | wave- | pumping | pumping | pumping | pumping | pumping |
| | length | power | power | power | power | power |
| | nm | mW | mW | mW | mW | mW |
| λ₁ | 1426.2 | 149.0 | 31.0 | 96.0 | 78.0 | 32.0 |
| λ₂ | 1438.5 | 161.0 | 36.0 | 108.0 | 54.0 | 78.0 |
| λ₃ | 1451.8 | 91.0 | 22.0 | 65.0 | 45.0 | 26.0 |
| λ₄ | 1466.0 | 83.0 | — | 105.0 | — | 100.0 |
| λ₅ | 1495.2 | 184.0 | — | 206.0 | — | 210.0 |

| | | | |
|---|---|---|---|
| Total power | 668.0 | 668.0 | 623.0 |
| mW | | | |

In claim 2 and Detailed Description of the invention of this application, it is described that the distribution of the power of pumping light to wavelengths is changed while the total power in bidirectional pumping is not changed. The expression “the total power is not changed” does not mean absolutely no change but may include a margin of error in an experiment as described above.

An error in pumping power is essentially identical with a difference in gain, and the two have a close relation to each other. For that reason, the expression means that, in the above experiment, it is not always that the pumping light power matches completely at the same time the gain matches completely; the gain could include the error when the pumping light power matches and, when the gain matches, the pumping light power could include the error. The expression also includes a case where the error is distributed to the pumping light power and to the gain at an appropriate ratio.

Specifics of the error range are shown below. In Embodiment 6, approximately identical wavelength gain profiles are obtained for respective experiment conditions as shown in FIG. 11. However, a more detailed comparison reveals that the profiles do not exactly coincide with each other. Like this, sometimes there is an error of a degree acceptable for practical use between a wavelength profile in backward pumping and a wavelength profile in bidirectional pumping due to fluctuation in wavelength spectrum shape among pumping lights and a difference in loss of a fiber having a wavelength dependency or various other losses in the experiment system.

This is described taking the results of Embodiment 6 as an example. First, a comparison is made on gain profiles obtained in the case when the pumping power is small on the short wavelength side in backward pumping and in bidirectional pumping (Bidirectional Pumping 1 in Table 6). The two are approximately equal to each other in total power of pumping light but are different from each other in gain profile by about 0.3 dB as shown in FIG. 11. On the other hand, in the case of Bidirectional Pumping 2 where the pumping power in bidirectional pumping is large on the short wavelength side (total power: 623 mW), the gain profile is at approximately the same level as the gain profiles of the other two cases that are equal to each other in total power of pumping light (total power: 668 mW). The total power of pumping light is lower in Bidirectional Pumping 2 than in the other two cases by about 0.3 dB.

A similar difference can be read from the experiment results of Embodiment 2 shown in FIG. 3 and of Embodiment 4 shown in FIG. 9. As to the total power of pumping light, the degree of match is fairly high between backward pumping and bidirectional pumping in both embodiments. As to the gain profile, however, there is a difference of about 0.3 dB between backward pumping and bidirectional pumping over a wavelength range of 1540 nm to 1580 nm in Embodiment 2. In Embodiment 4, there is a difference of about 0.2 dB in gain profile between backward pumping and bidirectional pumping in a long wavelength region where the wavelength is equal to or higher than 1590 nm, and the same degree of difference can be found in other wavelength regions although locally.

From these results, it is concluded that a local gain difference of about 0.3 dB at each wavelength or the same degree of difference in total power of pumping light is within a range of experiment error, and is hardly considered as a direct reflection of the experiment conditions. In other words, assuming that a difference of about 0.3 dB occurs on either of the positive side and the negative side at worst, a local gain difference, or a difference in total power of pumping light, of 0.5 to 0.6 dB can be deemed as within the normal range of error. This can be known also from the fact that a difference in wavelength profile of about 0.5 dB over the entire gain wavelength band is usually acceptable in actual systems.

(Embodiment 7)

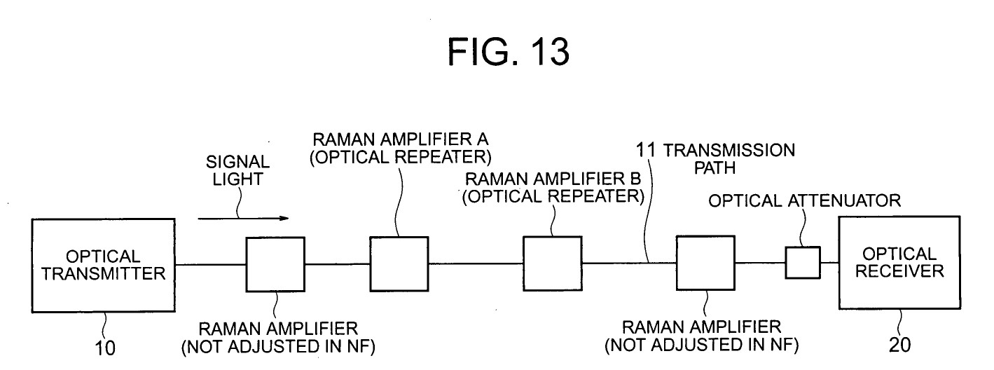

FIG. 13 shows an example of a Raman amplification method for an optical transmission system that uses as optical repeaters Raman amplifiers A and B. An electric signal is converted into signal light and is outputted from an optical transmitter 10 to a transmission path 11. The signal light is transmitted while its transmission loss is compensated for by Raman amplifiers A and B, which are connected in series to the transmission path 11. The signal light is received by an optical receiver 20 to be converted into an electric signal. The optical repeaters are an arbitrary combination of a Raman amplifier for bidirectional pumping, a Raman amplifier for backward pumping alone, and the like, and are adjusted to obtain a desired gain. At least one bidirectional pumping amplifier that can provide an arbitrary wavelength characteristic of NF in accordance with the present invention (the Raman amplifiers A and B in this embodiment) is connected to a part of the optical transmission system.

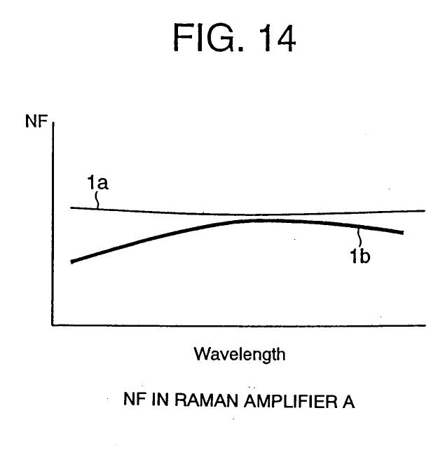

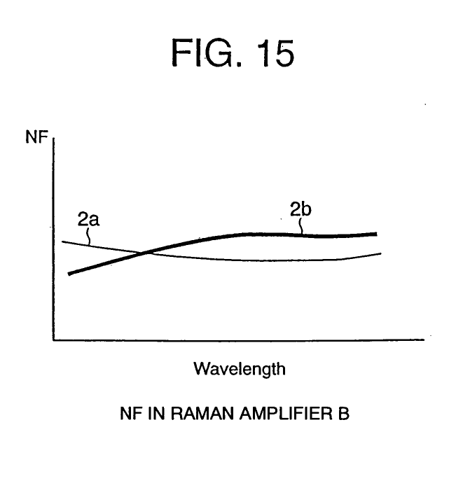

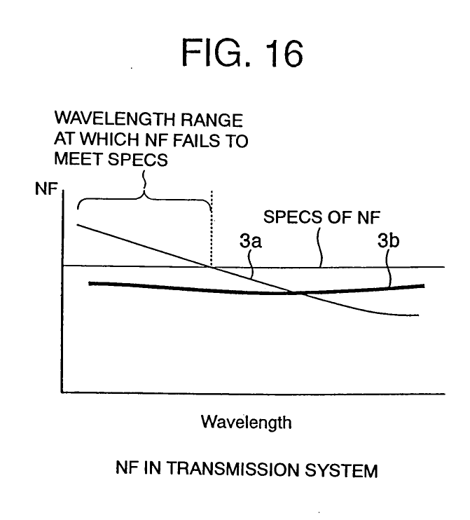

First, the wavelength characteristic of NF on the side of the optical receiver 20 is evaluated, and it is found that NF has failed to meet the value in specs at some wavelengths (3a of FIG. 16). In such case, NF's wavelength characteristics of the amplifiers A and B (1a and 2a of FIGS. 14 and 15, respectively) are adjusted to have arbitrary shapes (1b and 2b of FIGS. 14 and 15, respectively) that indicate a general increase or decrease with respect to an increase in wavelength. In this way, an adjustment can be made to obtain a desired NF (3b of FIG. 16) over the entire wavelength band of the optical transmission system without disturbing the wavelength characteristic of the gain.

If the adjustment of the Raman amplifiers A and B is accompanied with a change in gain wavelength profile, the gain can be adjusted by putting an optical attenuator that has a desired wavelength characteristic in front of the optical receiver 20.

The foregoing description in this embodiment is directed to a case where four Raman amplifiers are used in an optical transmission system. However, the number of Raman amplifiers is not limited as long as it is equal to or larger than 2. The number of Raman amplifiers that are adjusted in NF in this embodiment is two, but is not limited as long as it is equal to or larger than 1 and all Raman amplifiers that constitute an optical transmission system may be adjusted in NF.

### INDUSTRIAL APPLICABILITY

Raman amplification methods according to the present invention have following effects:

(1) Optical amplification in which NF is flat within a signal light band is achieved since the wavelengths and powers of two or more pumping lights are combined and bidirectional pumping is carried out by a part or all of the combined pumping lights.

(2) In addition to being capable of making an adjustment to render NF flat within a signal light band as described in (1), the method can adjust NF to have an arbitrary tendency such as a general increase or decrease with respect to an increase in wavelength since the wavelength and power of two or more pumping lights are combined and bidirectional pumping is carried out by a part or all of the combined pumping lights.

(3) The wavelengths and powers of two or more pumping lights are combined, bidirectional pumping is carried out by a part or all of the combined pumping lights, and plural Raman amplifiers are combined to include one or more Raman amplifiers that are adjusted in a manner that gives NF within a signal light band an arbitrary tendency such as a general increase or decrease with respect to an increase in wavelength. Therefore, the wavelength characteristic of NF can be compensated for among the plural Raman amplifiers and an optical transmission system in which the gain and NF are both flat with respect to an increase in wavelength is obtained.

(4) The wavelengths and powers of two or more pumping lights are combined, bidirectional pumping is carried out by a part or all of the combined pumping lights, and plural Raman amplifiers are combined to include one or more Raman amplifiers that are adjusted in a manner that gives NF within a signal light band an arbitrary tendency such as a general increase or decrease with respect to an increase in wavelength. Therefore, in addition to having NF that is flat with respect to an increase in wavelength as described in (3), the optical transmission system obtained is capable of setting the wavelength characteristic of NF arbitrarily in accordance with system's demand.

In a Raman amplification method according to claim 2 of the present invention, distribution of the power of pumping light to wavelengths in bidirectional pumping is changed while the total power of pumping light is not changed from that in backward pumping. Therefore, Raman optical amplification in which the gain is flat within a signal light band and is large as well can be achieved with a power equal to or approximately equal to the power used in backward pumping.

Raman amplification methods according to claims 3 and 4 of the present invention uses a part of combined pumping lights for forward pumping and all of the pumping lights in the combination for backward pumping, meaning that the pumping lights used in forward pumping are also used in backward pumping. Therefore, the problem of NF increasing on the short wavelength side when forward pumping alone or backward pumping alone is employed is solved and optical amplification in which NF is flat throughout a signal light band is achieved.

Raman amplification methods according to claims 5 and 6 of the present invention uses pumping lights on the short wavelength side out of combined pumping lights for forward pumping and all of the pumping lights in the combination for backward pumping, meaning that the pumping lights on the short wavelength side are used in both forward pumping and backward pumping. Therefore, the short wavelength side of signal light where the fiber loss is large is pumped by both forward pumping and backward pumping to reduce signal light degradation on the short wavelength side and to lower NF on the short wavelength side. Accordingly, optical amplification in which NF is flat throughout a signal light band is achieved.

In Raman amplification methods according to claims 7 through 12 of the present invention, the power of backward pumping light is set larger than the power of forward pumping light in any combination of pumping lights. Therefore, degradation of RIN caused by forward pumping, as well as an increase in NF on the short wavelength side which takes place when forward pumping alone or backward pumping alone is employed, are suppressed. In addition, optical amplification in which the gain is large can be achieved since backward pumping is carried out using high power pumping light.

Raman amplification methods according to claims 13 through 24 of the present invention uses iGM for an LD. Therefore, effects equal to or greater than those obtained when an existing LD is used can be anticipated.

In a Raman amplification method according to claim 25 of the present invention, an optical transmission system carries out a Raman amplification method according to any one of claims 1 through 24(?) in multiple stages and NF is adjusted at least at one point Therefore, effects similar to those of the Raman amplification methods of claims 1 through 24 can be obtained using an optical transmission system that performs Raman amplification in multiple stages.

In an optical transmission system according to claim 26 of the present invention, effects similar to those of the Raman amplification method of claim 25 can be obtained.

1. A Raman amplification method for pumping WDM signal light within an optical fiber, that uses pumping lights having two or more different pumping wavelengths, comprising steps of:
calculating a combination of optical power at said two or more different pumping wavelengths for said pumping lights in backward pumping so as to provide a substantially flat Raman gain within a predetermined signal wavelength band;
carrying out bidirectional pumping with at least part of said pumping lights wherein said bidirectional pumping includes said backward pumping; and
changing a respective distribution of pumping power to wavelength of said bidirectional pumping.

2. The Raman amplification method according to claim 1, wherein:
a total optical power of said bidirectional pumping is not changed from the combination of optical power of said backward pumping calculated in said calculating step.

3. The Raman amplification method according to claim 2, wherein:
all of said pumping lights are used for backward pumping and part of said pumping lights are used for forward pumping.

4. The Raman amplification method according to claim 3, wherein:
shorter wavelengths of said pumping lights are used for forward pumping.

5. The Raman amplification method according to claim 4, wherein:
the combination of optical power of backward pumping is larger than that of forward pumping.

6. The Raman amplification method according to claim 5, further comprising:
performing forward pumping with at least one multi-mode pumping laser having an LD with a grating structure.

7. The Raman amplification method according to claim 4, further comprising:
performing forward pumping with at least one multi-mode pumping laser having an LD with a grating structure.

8. The Raman amplification method according to claim 3, wherein:
the combination of optical power of backward pumping is larger than that of forward pumping.

9. The Raman amplification method according to claim 8, further comprising:
performing forward pumping with at least one multi-mode pumping laser having an LD with a grating structure.

10. The Raman amplification method according to claim 3, further comprising:
performing forward pumping with at least one multi-mode pumping laser having an LD with a grating structure.

11. The Raman amplification method according to claim 2, wherein:
shorter wavelengths of said pumping lights are used for forward pumping.

12. The Raman amplification method according to claim 11, wherein:
the combination of optical power of backward pumping is larger than that of forward pumping.

13. The Raman amplification method according to claim 12, further comprising:
performing forward pumping with at least one multi-mode pumping laser having an LD with a grating structure.

14. The Raman amplification according to claim 11, further comprising:
performing forward pumping with at least one multi-mode pumping laser having an LD with a grating structure.

15. The Raman amplification method according to claim 2, wherein:
the combination of optical power of backward pumping is larger than that of forward pumping.

16. The Raman amplification method according to claim 15, further comprising:
performing forward pumping with at least one multi-mode pumping laser having an LD with a grating structure.

17. The Raman amplification method according to claim 2, further comprising:
performing forward pumping with at least one multi mode pumping laser having an LD with a grating structure.

18. The Raman amplification method according to claim 1, wherein:
all of said pumping lights are used for backward pumping and part of said pumping lights are used for forward pumping.

19. The Raman amplification method according to claim 18, wherein:
shorter wavelengths of said pumping lights are used for forward pumping.

20. The Raman amplification method according to claim 19, wherein:
the combination of optical power of backward pumping is larger than that of forward pumping.

21. The Raman amplification method according to claim 20, further comprising:
performing forward pumping with at least one multi-mode pumping laser having an LD with a grating structure.

22. The Raman amplification method according to claim 19, further comprising:
performing forward pumping with at least one multi-mode pumping laser having an LD with a grating structure.

23. The Raman amplification method according to claim 18, wherein:
the combination of optical power of backward pumping is larger than that of forward pumping.

24. The Raman amplification method according to claim 23, further comprising:
performing forward pumping with at least one multi-mode pumping laser having an LD with a grating structure.

25. The Raman amplification method according to claim 18, further comprising:
performing forward pumping with at least one multi-mode pumping laser having an LD with a grating structure.

26. The Raman amplification method according claim 1, wherein:
shorter wavelengths of said pumping lights are used for forward pumping.

27. The Raman amplification method according to claim 26, wherein:
the combination of optical power of backward pumping is larger than that of forward pumping.

28. The Raman amplification method according to claim 27, further comprising:
performing forward pumping with at least one multi-mode pumping laser having an LD with a grating structure.

29. The Raman amplification method according to claim 26, further comprising:
performing forward pumping with at least one multi-mode pumping laser having an LD with a grating structure.

30. The Raman amplification method according to claim 1, wherein:
the combination of optical power of backward pumping is larger than that of forward pumping.

31. The Raman amplification method according to claim 30, further comprising:
performing forward pumping with at least one multi-mode pumping laser having an LD with a grating structure.

32. The Raman amplification method according to claim 1, further comprising:
performing forward pumping with at least one multi-mode pumping laser having an LD with a grating structure.

33. An optical transmission system that transmits a WDM optical signal through an optical transmission path comprising:
an optical transmitter configured to output said WDM optical signal into said optical transmission path;
two or more Raman amplifiers that are connected to said optical transmission path in series, and configured to Raman-amplify said WDM optical signal; and
an optical receiver configured to receive said WDM optical signal propagated through said optical transmission path, wherein:
at least one of said two or more Raman amplifiers is configured to adjust a wavelength characteristic of noise figure to provide a predetermined wavelength characteristic of noise figure for receiving said WDM optical signal at said optical receiver.

34. The optical transmission system according to claim 33 wherein:
one of said Raman amplifiers is configured to adjust a wavelength characteristic of noise figure by way of bidirectional pumping.

35. The optical transmission system according to claim 34 where in:
all pumping lights in said Raman amplifier are used for backward pumping and shorter wavelengths of the pumping lights are used for forward pumping.

36. The optical transmission system according to claim 35 wherein:
the wavelength characteristic of noise figure at said shorter wavelengths is substantially due to the backward pumping, and only backward pumping provides a same wavelength characteristic as that for the Raman gain, and is approximately the same as a gain for when bidirectional pumping is performed with lights for backward pumping turned off.
